(19) United States
(12) Patent Application Publication
(10) Pub. No.: US 2011/0289430 A1
(43) Pub. Date: Nov. 24, 2011

(54) SYSTEM AND METHOD FOR MAINTAINING VIRTUAL WORLD ANONYMITY

(75) Inventor: Dan Frank, Falls Church, VA (US)

(73) Assignee: Three Wire Systems, LLC, Vienna, VA (US)

(21) Appl. No.: 12/782,549

(22) Filed: May 18, 2010

(51) Int. Cl. G06F 15/16; G06F 3/01

(52) U.S. Cl. 715/753; 709/203; 709/206

(57) ABSTRACT

Interaction in a virtual space may be facilitated among a super user and one or more users while preserving anonymity between the one or more users. The super user may be an individual that provides guidance or counseling to users within the virtual space regarding personal matters. As such, interactions between the super user and the one or more users may be based at least in part on confidential information respectively associated with the one or more users. The super user can obtain confidential information without exposing the identity of an associated user. Since anonymity is preserved, the one or more users can interact freely with the super user without concern of being identified.

### FIELD OF THE INVENTION

The invention relates to facilitating interaction in a virtual space among a super user and one or more users while preserving anonymity between the one or more users, wherein the interaction is based at least in part on confidential information respectively associated with the one or more users.

### BACKGROUND OF THE INVENTION

Conventionally, identifying-information associated with a user of a virtual space may not be kept private from other users of that virtual space. Furthermore, individuals that maintain a system providing the virtual space may have the ability to ascertain such identifying-information. The possibility of compromised anonymity within a virtual space may make some users hesitant to discuss or otherwise disclose personal matters, such as medical or financial matters. As such, the potential effectiveness may be reduced for an individual seeking to provide guidance or counseling regarding such personal matters within the virtual space.

### SUMMARY

One aspect of the invention relates to a system for facilitating interaction in a virtual space among a super user and one or more users while preserving anonymity between the one or more users. The super user may be an individual that provides guidance or counseling to users within the virtual space regarding personal matters (e.g., health matters, finance matters, and/or other personal matters). As such, interactions between the super user and the one or more users may be based at least in part on confidential information respectively associated with the one or more users. The super user can obtain confidential information without exposing the identity of an associated user. Since anonymity is preserved, the one or more users can interact freely with the super user without concern of being identified by other users, by system administrators of the virtual space, by individuals that access the virtual space and/or virtual space user information in an unauthorized manner, and/or other individuals.

A network environment may include one or more virtual space servers and one or more private data servers. The virtual space servers may be accessed by a user virtual space client and/or a super user virtual space client via a first network. The private data servers may be accessed by a super user confidential data client via a second network. The super user virtual space client and the super user confidential data client may be comprised by the same computing platform, or may be physically separate and distinct computing platforms.

A given client such as the user virtual space client, the super user virtual space client, and/or the super user confidential data client may include one or more processors configured to execute computer program modules. The computer program modules may be configured to enable one or more user, super users, and/or other individuals associated with the given client to interface with one or more servers such as the virtual space servers and/or the private data servers, and/or provide other functionality attributed herein to various clients.

The virtual space servers may include hardware, software, and/or firmware configured to provide, or serve, one or more virtual spaces. As used herein, a virtual space may comprise a simulated space (e.g., a physical space) instanced on a server (e.g., virtual space servers) that may be accessible by a client (e.g., the user virtual space client and/or the super user virtual space client) located remotely from the server to format a view of the virtual space for display to a user. The simulated space may have a topography, express ongoing real-time interaction by the user, and/or include one or more objects positioned within the topography that are capable of locomotion within the topography. In some instances, the topography may be a 2-dimensional topography. In other instances, the topography may be a 3-dimensional topography. The topography may include dimensions of the virtual space, and/or surface features of a surface or objects that are “native” to the virtual space. In some instances, the topography may describe a surface (e.g., a ground surface) that runs through at least a substantial portion of the virtual space. In some instances, the topography may describe a volume with one or more bodies positioned therein (e.g., a simulation of gravity-deprived space with one or more celestial bodies positioned therein). A virtual space may include a virtual world, but this is not necessarily the case. For example, a virtual space may include a game space that does not include one or more of the aspects generally associated with a virtual world (e.g., gravity, a landscape, etc.).

Within the virtual space provided by the virtual space servers, avatars associated with the users may be controlled by the users to interact with each other. As used herein, the term “avatar” may refer to an object (or group of objects) present in the virtual space that represents an individual user. The avatar may be controlled by the user with which it is associated. The avatars may interact with each other by physical interaction within the instanced virtual space, through text chat, through voice chat, and/or through other interactions. The avatar associated with a given user may be created and/or customized by the given user. The avatar may be associated with an “inventory” of virtual goods and/or currency such as that contained in a transactional fund that the user can use (e.g., by manipulation of the avatar and/or the items) within the virtual space.

The virtual space servers may comprise electronic storage, one or more processor(s), and/or other components. The private data servers may comprise electronic storage, one or more processor(s), and/or other components. Generally speaking, electronic storage may comprise electronic storage media that electronically stores information. The electronic storage media of the electronic storage may include one or both of system storage that is provided integrally (i.e., substantially non-removable) with a server (e.g., the virtual space servers and/or the private data servers) and/or removable storage that is removably connectable to a server (e.g., the virtual space servers and/or the private data servers). Electronic storage may store software algorithms, information determined by a processor, information received from a server (e.g., the virtual space servers and/or the private data servers), information received from a client (e.g., the user virtual space client, the super user virtual space client, and/or the super user confidential data client), and/or other information that enables virtual space servers and/or the private data servers to function properly.

One or more processors may be configured to provide information processing capabilities in virtual space servers and private data servers. Such processors may include one or more of a digital processor, an analog processor, a digital circuit designed to process information, an analog circuit designed to process information, a state machine, and/or other mechanisms for electronically processing information.

The processor(s) associated with the virtual space servers may be configured to execute one or more computer program modules. The one or more computer program modules may include one or more of a virtual space module, and/or other modules. The virtual space module may be configured to provide, to one or more user virtual space clients (e.g., the user virtual space client) for presentation to one or more users, access to the virtual space. The virtual space module may be configured to provide, to the super user virtual space client for presentation to the super user, assess to the virtual space. Within the virtual space, interaction is facilitated among the super user and one or more users (e.g., a user of the user virtual space client). Individual ones of the one or more users and/or the super user may be associated with corresponding aliases. An alias may be any false name used to conceal one's identity. As a non-limiting example, a user or super user whose real-world name is “John Smith” may use “Cat123” as an alias. The real-world identity of a given user cannot be ascertained by others of the one or more users based on the alias corresponding to the given user. Individual ones of the one or more users and/or the super user may be represented in the virtual space by corresponding avatars associated with the corresponding aliases.

The processor(s) associated with the private data servers may be configured to execute one or more computer program modules. The one or more computer program modules may include one or more of a confidential data extraction module, an alias matching module, an alias assignment module, and/or other modules. The confidential data extraction module may be configured to provide, to the super user confidential data client for presentation to the super user, confidential information associated with a given user. Confidential information may include medical records, financial information, academic information, legal information, and/or any other information desired to be confidential by an individual. Presentation of the confidential information associated with the given user to the super user on the super user confidential data client may provide a basis for communication between the super user and the given user related to real world circumstances of the given user. To illustrate, the super user may be interacting with the given user within the virtual space via the super user virtual space client. The given user may inquire with the super user regarding a medical issue of the given user. The super user may access medical records associated with the given user via the super user confidential data client through execution of the confidential data extraction module. Access to the medical records may allow the super user to better assist the given user.

In implementations where the super user virtual space client and the super user confidential data client are physically separate and distinct, risk of compromising anonymity of the given user is reduced since identifying-information of the given user is not known to any individual associated with the virtual space, except the given user and, depending on the particular implementation, possibly the super user. The confidential data extraction module may be configured to obtain the confidential information associated with the given user based on obtained identification information of the given user. Such obtained identification information may be garnered in a number of ways. Examples relating to obtaining identification information are described in connection with the alias matching module.

The alias matching module may be configured to provide, to the super user confidential data client for presentation to the super user, identification information related to the real-world identity of the given user. The alias-user matching module may be configured to obtain the identification information of the given user based on the alias corresponding to the given user. For example, the super user may input the alias of the given user and be returned the real-world name of the given user. The real-world name of the given user may then be used in conjunction with the confidential data extraction module to obtain confidential information associated with the given user. In some implementations, the super user may enter the alias of the given user and obtain confidential information associated with the given user without ever learning the real-world identity of the given user.

The alias assignment module may be configured to assign aliases corresponding to individual ones of the one or more users. By assigning aliases, anonymity may be protected by preventing users from accidentally assigning themselves potentially self-identifying aliases. The assigned aliases may be provided to individual ones of the one or more users via a communication channel outside of the virtual space. By way of non-limiting example, the communication channel outside of the virtual space may include electronic mail, conventional postal delivery service, and/or any other communication channel outside of the virtual space. By providing the assigned aliases to the corresponding users via communication channels outside of the virtual space, the chances of that information being intercepted by an individual associated with the virtual space is reduced.

Another aspect of the invention relates to a method for facilitating interaction in a virtual space among a super user and one or more users while preserving anonymity between the one or more users. The interaction may be based at least in part on confidential information respectively associated with the one or more users. The operations of the method presented below are intended to be illustrative. In some implementations, the method may be accomplished with one or more additional operations not described, and/or without one or more of the operations discussed. Additionally, the order in which the operations of the method is not intended to be limiting.

At one operation, aliases are assigned corresponding to individual ones of one or more users. The assigned aliases may be provided to the corresponding users via the virtual space and/or via a communication channel outside of the virtual space. Examples of communication channels outside of the virtual space include electronic mail, conventional postal delivery service, and/or any other communication channel outside of the virtual space. According to some implementations, this operation may be performed by executing the alias assignment module.

At another operation, access is provided by the super user, via a first client (e.g., the super user virtual space client), to the virtual space in which interaction is facilitated among the super user and the one or more users. The virtual space may be provided via execution of the virtual space module. Individual ones of the one or more users may be associated with corresponding aliases. The real-world identity of a given user cannot be ascertained by others of the one or more users based on the alias corresponding to the given user. Individual ones of the one or more users may be represented in the virtual space by corresponding avatars associated with the corresponding alias.

At yet another operation, the super user is provided, via a second client (e.g., the super user confidential data client), identification information related to the real-world identity of a given user. The identification information related to the real-world identity of the given user may be based on the alias corresponding to the given user. In some implementations, this operation is performed through execution of the alias matching module.

At still another operation, access is provided by the super user, via a second client (e.g., super user confidential data client), to confidential information associated with the given user. The access by the super user to the confidential information may provide a basis for communication between the super user and the given user related to real-world circumstances of the given user. The confidential information associated with the given user may be obtained based on the identification information of the given user provided in operation. This operation may be performed through execution of the confidential data extraction module, in accordance with some implementations.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates an exemplary environment in which implementations of the present technology may be practiced.

FIG. 2 illustrates a method for facilitating interaction in a virtual space among a super user and one or more users while preserving anonymity between the one or more users.

### DETAILED DESCRIPTION

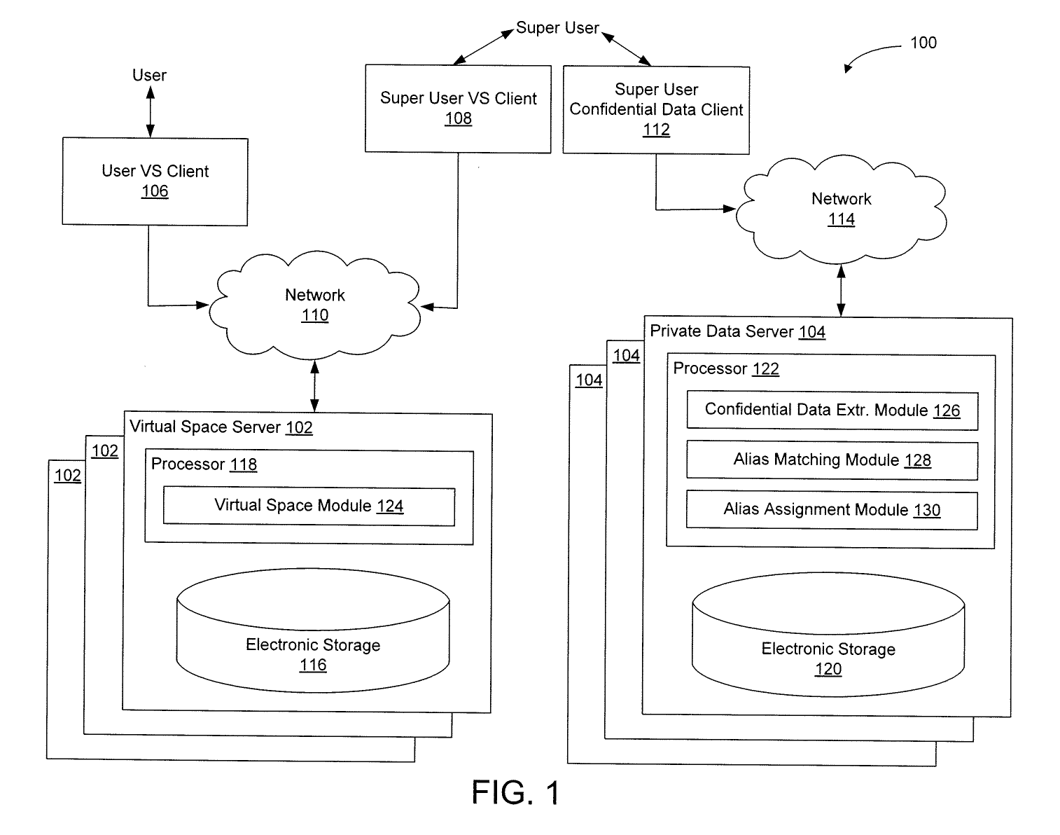

FIG. 1 illustrates an exemplary environment 100 in which implementations of the present technology may be practiced. In network environments such as the environment 100, a super user may interact within a virtual space with one or more users while preserving anonymity between the one or more users. The super user may be an individual that provides guidance or counseling to users within the virtual space regarding personal matters (e.g., health matters, finance matters, and/or other personal matters). As such, interactions between the super user and the one or more users may be based at least in part on confidential information respectively associated with the one or more users. The super user can obtain confidential information without exposing the identity of an associated user. Since anonymity is preserved, the one or more users can interact freely with the super user without concern of being identified by other users, by system administrators of the virtual space, by individuals that access the virtual space and/or virtual space user information in an unauthorized manner, and/or other individuals.

The environment 100 may include one or more virtual space servers 102 and one or more private data servers 104. The virtual space servers 102 may be accessed by a user virtual space client 106 and/or a super user virtual space client 108 via a first network. The private data servers 104 may be accessed by a super user confidential data client 112 via a network 114. The super user virtual space client 108 and the super user confidential data client 112 may be comprised by the same computing platform, or may be physically separate and distinct computing platforms. Although FIG. 1 depicts a single user virtual space client 106, a single super user virtual space client 108, and a single super user confidential data client 112, it is appreciated that the environment 100 may include any number of user virtual space clients similar to or the same as the user virtual space client 106, any number of super user virtual space clients similar to or the same as the super user virtual space client 108, and any number of super user confidential data clients similar to or the same as the super user confidential data client 112.

The networks 110 and 114 may include the Internet and/or other networks. It will be appreciated that this is not intended to be limiting, and that the scope of this disclosure includes implementations in which the virtual space servers 102, the private data servers 104, the user virtual space client 106, the super user virtual space client 108, and/or the super user confidential data client 112 are operatively linked via some other communication media. In some implementations, the networks 110 and 114 may overlap, or be one and same. In some implementations, the networks 110 and 114 may be physically separate and distinct.

A given client such as the user virtual space client 106, the super user virtual space client 108, and/or the super user confidential data client 112 may include one or more processors configured to execute computer program modules. The computer program modules may be configured to enable one or more user, super users, and/or other individuals associated with the given client to interface with one or more servers such as the virtual space servers 102 and/or the private data servers 104, and/or provide other functionality attributed herein to various clients. By way of non-limiting example, the user virtual space client 106, the super user virtual space client 108, and/or the super user confidential data client 112 may include one or more of a desktop computer, a laptop computer, a handheld computer, a portable digital assistant (PDA), a NetBook, a Smartphone, and/or other computing platforms.

The virtual space servers 102 may include hardware, software, and/or firmware configured to provide, or serve, one or more virtual spaces. As used herein, a virtual space may comprise a simulated space (e.g., a physical space) instanced on a server (e.g., virtual space servers 102) that may be accessible by a client (e.g., the user virtual space client 106 and/or the super user virtual space client 108) located remotely from the server to format a view of the virtual space for display to a user. The simulated space may have a topography, express ongoing real-time interaction by the user, and/or include one or more objects positioned within the topography that are capable of locomotion within the topography. In some instances, the topography may be a 2-dimensional topography. In other instances, the topography may be a 3-dimensional topography. The topography may include dimensions of the virtual space, and/or surface features of a surface or objects that are “native” to the virtual space. In some instances, the topography may describe a surface (e.g., a ground surface) that runs through at least a substantial portion of the virtual space. In some instances, the topography may describe a volume with one or more bodies positioned therein (e.g., a simulation of gravity-deprived space with one or more celestial bodies positioned therein). A virtual space may include a virtual world, but this is not necessarily the case. For example, a virtual space may include a game space that does not include one or more of the aspects generally associated with a virtual world (e.g., gravity, a landscape, etc.).

Within the virtual space provided by the virtual space servers 102, avatars associated with the users may be controlled by the users to interact with each other. As used herein, the term “avatar” may refer to an object (or group of objects) present in the virtual space that represents an individual user. The avatar may be controlled by the user with which it is associated. The avatars may interact with each other by physical interaction within the instanced virtual space, through text chat, through voice chat, and/or through other interactions. The avatar associated with a given user may be created and/or customized by the given user. The avatar may be associated with an “inventory” of virtual goods and/or currency such as that contained in a transactional fund that the user can use (e.g., by manipulation of the avatar and/or the items) within the virtual space.

The virtual space servers 102 may comprise electronic storage 116, one or more processor(s) 118, and/or other components. The private data servers 104 may comprise electronic storage 120, one or more processor(s) 122, and/or other components. The electronic storage 116 and/or the electronic storage 120 may comprise electronic storage media that electronically stores information. The electronic storage media of the electronic storage 116 and/or the electronic storage 120 may include one or both of system storage that is provided integrally (i.e., substantially non-removable) with a server (e.g., the virtual space servers 102 and/or the private data servers 104) and/or removable storage that is removably connectable to a server (e.g., the virtual space servers 102 and/or the private data servers 104) via, for example, a port (e.g., a USB port, a firewire port, etc.) or a drive (e.g., a disk drive, etc.). The electronic storage 116 and/or the electronic storage 120 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 116 and/or the electronic storage 120 may store software algorithms, information determined by a processor (e.g., the processor(s) 118 and/or the processor(s) 122), information received from a server (e.g., the virtual space servers 102 and/or the private data servers 104), information received from a client (e.g., the user virtual space client 106, the super user virtual space client 108, and/or the super user confidential data client 112), and/or other information that enables virtual space servers 102 and/or the private data servers 104 to function properly.

The processor(s) 118 may be configured to provide information processing capabilities in virtual space servers 102, while the processor(s) 122 may be configured to provide information processing capabilities to private data servers 104. As such, the processor(s) 118 and/or the processor(s) 122 may include one or more of a digital processor, an analog processor, a digital circuit designed to process information, an analog circuit designed to process information, a state machine, and/or other mechanisms for electronically processing information. Although the processor(s) 118 and the processor(s) 122 are shown in FIG. 1 as a single entities, this is for illustrative purposes only. In some implementations, the processor(s) 118 and/or the processor(s) 122 may include a plurality of processing units. These processing units may be physically located within the same device, or may represent processing functionality of a plurality of devices operating in coordination (e.g., the virtual space servers 102, the user virtual space client 106, and/or the super user virtual space client 108).

As is shown in FIG. 1, the processor(s) 118 may be configured to execute one or more computer program modules. The one or more computer program modules may include one or more of a virtual space module 124, and/or other modules. The processor(s) 118 may be configured to execute modules (e.g., the virtual space module 124) by software; hardware; firmware; some combination of software, hardware, and/or firmware; and/or other mechanisms for configuring processing capabilities on the processor(s) 118.

It should be appreciated that although the virtual space module 124 is illustrated in FIG. 1 as being located within a single processing unit, in implementations in which processor(s) 118 includes multiple processing units, one or more instances of the virtual space module 124 may be located remotely from other instances of the virtual space module 124. In implementations in which the virtual space servers 102 operates in a coordinated manner with the user virtual space client 106 and/or the super user virtual space client 108 to provide the functionality described herein with respect to the processor(s) 118, some or all of the functionality attributed to the virtual space module 124 may be provided by modules executed on processors of the user virtual space client 106 and/or the super user virtual space client 108. The description of the functionality provided by the virtual space module 124 described below is for illustrative purposes, and is not intended to be limiting, as the virtual space module 124 may provide more or less functionality than is described. For example, some or all of the functionality attributed to the virtual space module 124 may be provided by one or more other modules.

The virtual space module 124 may be configured to provide, to one or more user virtual space clients (e.g., the user virtual space client 106) for presentation to one or more users, access to the virtual space. The virtual space module 124 may be configured to provide, to the super user virtual space client 108 for presentation to the super user, assess to the virtual space. Within the virtual space, interaction is facilitated among the super user and one or more users (e.g., a user of the user virtual space client 106). Individual ones of the one or more users and/or the super user may be associated with corresponding aliases. An alias may be any false name used to conceal one's identity. As a non-limiting example, a user or super user whose real-world name is “John Smith” may use “Cat123” as an alias. The real-world identity of a given user cannot be ascertained by others of the one or more users based on the alias corresponding to the given user. Individual ones of the one or more users and/or the super user may be represented in the virtual space by corresponding avatars associated with the corresponding aliases.

Referring still to FIG. 1, the processor(s) 122 may be configured to execute one or more computer program modules. The one or more computer program modules may include one or more of a confidential data extraction module 126, an alias matching module 128, an alias assignment module 130, and/or other modules. Processor 122 may be configured to execute modules 126, 128, and/or 130 by software; hardware; firmware; some combination of software, hardware, and/or firmware; and/or other mechanisms for configuring processing capabilities on the processor(s) 122.

It should be appreciated that although modules 126, 128, and 130 are illustrated in FIG. 1 as being co-located within a single processing unit, in implementations in which the processor(s) 122 includes multiple processing units, one or more of modules 126, 128, and/or 130 may be located remotely from the other modules. In implementations in which the private data servers 104 and the super user confidential data client 112 operate in a coordinated manner to provide the functionality described herein with respect to the processor(s) 122, some or all of the functionality attributed to one or more of 126, 128, and/or 130 may be provided by the modules executed on processors of the super user confidential data client 112. The description of the functionality provided by the different modules 126, 128, and/or 130 described below is for illustrative purposes, and is not intended to be limiting, as any of modules 126, 128, and/or 130 may provide more or less functionality than is described. For example, one or more of modules 126, 128, and/or 130 may be eliminated, and some or all of its functionality may be provided by other ones of modules 126, 128, and/or 130. As another example, the processor(s) 122 may be configured to execute one or more additional modules that may perform some or all of the functionality attributed below to one of modules 126, 128, and/or 130.

The confidential data extraction module 126 may be configured to provide, to the super user confidential data client 112 for presentation to the super user, confidential information associated with a given user. Confidential information may include medical records, financial information, academic information, legal information, and/or any other information desired to be confidential by an individual. Presentation of the confidential information associated with the given user to the super user on the super user confidential data client 112 may provide a basis for communication between the super user and the given user related to real world circumstances of the given user. To illustrate, the super user may be interacting with the given user within the virtual space via the super user virtual space client 108. The given user may inquire with the super user regarding a medical issue of the given user. The super user may access medical records associated with the given user via the super user confidential data client 112 through execution of the confidential data extraction module 126. Access to the medical records may allow the super user to better assist the given user.

In implementations where the super user virtual space client 108 and the super user confidential data client 112 are physically separate and distinct, risk of compromising anonymity of the given user is reduced since identifying-information of the given user is not known to any individual associated with the virtual space, except the given user and, depending on the particular implementation, possibly the super user. The confidential data extraction module 126 may be configured to obtain the confidential information associated with the given user based on obtained identification information of the given user. Such obtained identification information may be garnered in a number of ways. Examples relating to obtaining identification information are described in connection with the alias matching module 128.

The alias matching module 128 may be configured to provide, to the super user confidential data client 112 for presentation to the super user, identification information related to the real-world identity of the given user. The alias-user matching module 128 may be configured to obtain the identification information of the given user based on the alias corresponding to the given user. For example, the super user may input the alias of the given user and be returned the real-world name of the given user. The real-world name of the given user may then be used in conjunction with the confidential data extraction module 126 to obtain confidential information associated with the given user. In some implementations, the super user may enter the alias of the given user and obtain confidential information associated with the given user without ever learning the real-world identity of the given user.

The alias assignment module 130 may be configured to assign aliases corresponding to individual ones of the one or more users. By assigning aliases, anonymity may be protected by preventing users from accidentally assigning themselves potentially self-identifying aliases. The assigned aliases may be provided to individual ones of the one or more users via a communication channel outside of the virtual space. By way of non-limiting example, the communication channel outside of the virtual space may include electronic mail, conventional postal delivery service, and/or any other communication channel outside of the virtual space. By providing the assigned aliases to the corresponding users via communication channels outside of the virtual space, the chances of that information being intercepted by an individual associated with the virtual space is reduced.

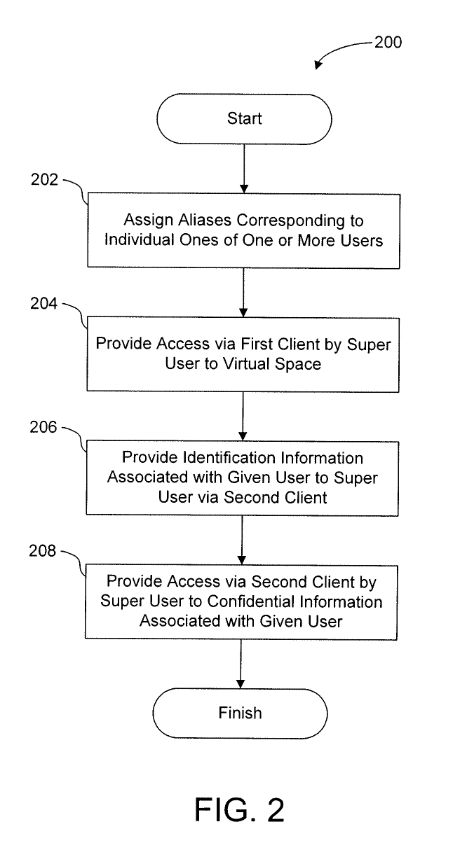

FIG. 2 illustrates a method 200 for facilitating interaction in a virtual space among a super user and one or more users while preserving anonymity between the one or more users. The interaction may be based at least in part on confidential information respectively associated with the one or more users. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

At an operation 202, aliases are assigned corresponding to individual ones of one or more users. The assigned aliases may be provided to the corresponding users via the virtual space and/or via a communication channel outside of the virtual space. Examples of communication channels outside of the virtual space include electronic mail, conventional postal delivery service, and/or any other communication channel outside of the virtual space. According to some implementations, operation 202 may be performed by executing the alias assignment module 130.

At an operation 204, access is provided by the super user, via a first client (e.g., the super user virtual space client 108), to the virtual space in which interaction is facilitated among the super user and the one or more users. The virtual space may be provided via execution of the virtual space module 124. Individual ones of the one or more users may be associated with corresponding aliases. The real-world identity of a given user cannot be ascertained by others of the one or more users based on the alias corresponding to the given user. Individual ones of the one or more users may be represented in the virtual space by corresponding avatars associated with the corresponding alias.

At an operation 206, the super user is provided, via a second client (e.g., the super user confidential data client 112), identification information related to the real-world identity of a given user. The identification information related to the real-world identity of the given user may be based on the alias corresponding to the given user. In some implementations, operation 206 is performed through execution of the alias matching module 128.

At an operation 208, access is provided by the super user, via a second client (e.g., super user confidential data client 112), to confidential information associated with the given user. The access by the super user to the confidential information may provide a basis for communication between the super user and the given user related to real-world circumstances of the given user. The confidential information associated with the given user may be obtained based on the identification information of the given user provided in operation 206. Operation 208 may be performed through execution of the confidential data extraction module 126, in accordance with some implementations.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A system for facilitating interaction in a virtual space among a super user and one or more users while preserving anonymity between the one or more users, the interaction based at least in part on confidential information respectively associated with the one or more users, the system comprising:
a first server accessible by the super user via a first client, the first server including one or more processors configured to execute computer program modules, the computer program modules comprising:
a virtual space module configured to provide, to the first client for presentation to the super user, access to the virtual space in which interaction is facilitated among the super user and the one or more users, wherein individual ones of the one or more users are associated with corresponding aliases, and wherein the real-world identity of a given user cannot be ascertained by others of the one or more users based on the alias corresponding to the given user; and
a second server accessible by the super user via a second client, the second server concurrently accessible with the first server, the second client being physically separate and distinct from the first client, the second server including one or more processors configured to execute computer program modules, the computer program modules comprising:
a confidential data extraction module configured to provide, to the second client for presentation to the super user, confidential information associated with the given user, wherein presentation of the confidential information associated with the given user to the super user on the second client provides a basis for communication between the super user and the given user related to real world circumstances of the given user.

2. The system of claim 1, wherein the computer program modules executable by the second server further include an alias-user matching module configured to provide, to the second client for presentation to the super user, identification information related to the real-world identity of the given user, the alias-user matching module being configured to obtain the identification information of the given user based on the alias corresponding to the given user.

3. The system of claim 2, wherein the confidential data extraction module is configured to obtain the confidential information associated with the given user based on the obtained identification information of the given user.

4. The system of claim 1, wherein the first server is communicatively coupled with the first client via a first communications network, and wherein the second server is communicatively coupled with the second client via a second communications network, the first communications network being separate and distinct from the second communications network.

5. The system of claim 1, wherein the computer program modules executable by the second server further include an alias assignment module configured to assign aliases corresponding to individual ones of the one or more users.

6. The system of claim 5, wherein the assigned aliases are provided to individual ones of the one or more users via a communication channel outside of the virtual space.

7. The system of claim 6, wherein the communication channel outside of the virtual space includes electronic mail.

8. The system of claim 6, wherein the communication channel outside of the virtual space includes a conventional postal delivery service.

9. The system of claim 1, wherein individual ones of the one or more users are represented in the virtual space by corresponding avatars associated with the corresponding aliases.

10. The system of claim 1, wherein the confidential information includes medical records.

11. The system of claim 1, wherein the confidential information includes financial information.

12. A method for facilitating interaction in a virtual space among a super user and one or more users while preserving anonymity between the one or more users, the interaction based at least in part on confidential information respectively associated with the one or more users, the method comprising:
executing computer program modules on one or more processors of one or more computing devices;
providing access by the super user, via a first client, to the virtual space in which interaction is facilitated among the super user and the one or more users, wherein individual ones of the one or more users are associated with corresponding aliases, and wherein the real-world identity of a given user cannot be ascertained by others of the one or more users based on the alias corresponding to the given user; and
providing access by the super user, via a second client, to confidential information associated with the given user, wherein access by the super user to the confidential information provides a basis for communication between the super user and the given user related to real-world circumstances of the given user, and wherein the second client is physically separate and distinct from the first client.

13. The method of claim 12, further comprising providing to the super user, via the second client, identification information related to the real-world identity of the given user, wherein the identification information relating to the real-world identity of the given user is based on the alias corresponding to the given user.

14. The method of claim 13, wherein the confidential information associated with the given user is obtained based on the provided identification information of the given user.

15. The method of claim 12, further comprising assigning aliases corresponding to individual ones of the one or more users.

16. The method of claim 15, further comprising providing, to individual ones of the one or more users, the assigned aliases corresponding to individual ones of the one or more users via a communication channel outside of the virtual space.

17. The method of claim 16, wherein the communication channel outside of the virtual space includes electronic mail.

18. The method of claim 16, wherein the communication channel outside of the virtual space includes a conventional postal delivery service.

19. The method of claim 12, further comprising representing individual ones of the one or more users in the virtual space by corresponding avatars associated with the corresponding alias.

20. The method of claim 12, wherein the confidential information includes medical records.

21. The method of claim 12, wherein the confidential information includes financial information.

22. A computer readable storage medium having instructions embodied thereon, the instructions executable by one or more processors to perform a method for facilitating interaction in a virtual space among a super user and one or more users while preserving anonymity between the one or more users, the interaction based at least in part on confidential information respectively associated with the one or more users, the method comprising:
providing access by the super user, via a first client, to the virtual space in which interaction is facilitated among the super user and the one or more users, wherein individual ones of the one or more users are associated with corresponding aliases, and wherein the real-world identity of a given user cannot be ascertained by others of the one or more users based on the alias corresponding to the given user; and
providing access by the super user, via a second client, to confidential information associated with the given user, wherein access by the super user to the confidential information provides a basis for communication between the super user and the given user related to real-world circumstances of the given user, and wherein the second client is physically separate and distinct from the first client.
